(19) United States
(12) Patent Application Publication
(10) Pub. No.: US 2010/0291415 A1
(43) Pub. Date: Nov. 18, 2010

(54) Methods for increasing carbon monoxide tolerance in fuel cells

(76) Inventors: Johna Leddy, Iowa City,, IA (US); Wayne L. Gellett, Ballwin, MO (US); Drew C. Dunwoody, St. Paul, MN (US)

Correspondence Address: FOLEY AND LARDNER LLP;SUITE 500, 3000 K STREET NW, WASHINGTON, DC, 20007, US

(21) Appl. No.: 11/632,202

(22) PCT Filed: Jul. 14, 2005
(86) PCT No.: PCT/US05/25113

§ 371 Date: Mar. 30, 2009

Related U.S. Application Data
(60) Provisional application No. 60/587,909, filed on Jul. 15, 2004.
(60) Provisional application No. 60/587,908, filed on Jul. 15, 2004.

(51) Int. Cl. H01M 2/00; H01M 8/06

(52) U.S. Cl. 429/10; 429/425

(57) ABSTRACT

Disclosed are methods for improving performance of fuel cells employing reformate fuels. The disclosed methods include employing a magnetically modified fuel cell and contacting the fuel cell anode with a reformate fuel stream that contains an amount of oxygen effective to increase carbon monoxide tolerance of the fuel cell.

This application claims priority to U.S. Provisional Application No. 60/587,908, filed Jul. 15, 2004 and U.S. Provisional Application No. 60/587,909, filed Jul. 15, 2004. The entire disclosure of the prior applications are considered as being part of the disclosure of this application and are hereby incorporated by reference herein.

### BACKGROUND OF THE INVENTION

1. Field of the Invention

The present invention is directed to methods for improving performance of fuel cells by employing a magnetically modified fuel cell and incorporating an amount of oxygen, e.g., as gaseous oxygen or air, effective to increase performance of the fuel cell into the reformate fuel stream.

2. Background of the Related Art

A fuel cell is a device that converts the energy of a chemical reaction into electricity. It differs from a battery primarily in that the fuel and oxidant are stored external to the cell, which can therefore generate power only as long as the fuel and oxidant are supplied. Moreover, unlike secondary batteries, fuel cells do not undergo charge/discharge cycles.

A fuel cell produces an electromotive force by bringing the fuel and oxidant into contact with two suitable, but different, electrodes separated by an electrolyte, such as a polymer electrolyte membrane (PEM). A fuel, such as hydrogen gas, is introduced at a first electrode, where it reacts electrochemically in the presence of the electrolyte to produce electrons and protons in the first electrode.

These electrons are then circulated from the first electrode to a second electrode through an electrical circuit connecting the electrodes. Protons pass through the electrolyte to the second electrode.

At the same time as the fuel is introduced to the first electrode, an oxidant, such as oxygen gas or air, is introduced to the second electrode, where it reacts electrochemically in presence of the electrolyte to consume the electrons that have circulated through the electrical circuit and the protons that have passed through the electrolyte.

The first electrode is therefore an oxidizing electrode, while the second electrode is a reducing electrode. Thus, in the case of H₂/O₂ and H₂/air cells, the respective half-cell reactions at the two electrodes are:

H₂→2H⁺+2e−; and (1)

½O₂+2H⁺+2e−→H₂O. (2)

The electrical circuit connecting the two electrodes withdraws electrical current from the cell and thus receives electrical power. The overall fuel cell reaction produces electrical energy according to the sum of the separate half-cell reactions above. In addition to electrical energy, water is formed at the cathode as a byproduct of the reaction as well as some heat energy.

For many practical applications, fuel cells are usually not operated as single units due, at least in part, to the relatively low electrical energy produced by individual cells. Rather, fuel cells may be connected in a series, stacked one on top of the other, or placed side by side.

In fuel cells containing a polymer electrolyte membrane (PEM), the PEM acts both as the electrolyte and as a barrier that prevents the mixing of the reactant gases, a potentially disastrous situation. Examples of suitable membrane materials are the polymeric perfluorocarbon ionomers generally containing a basic unit of fluorinated carbon chain and one or more sulfonic acid groups. There may be variations in the molecular configurations and/or molecular weights of this membrane. One such membrane commonly used as a fuel cell PEM is sold by E. I. DuPont de Nemours under the trademark “Nafion.”

Typically, a fuel cell uses oxygen and hydrogen as fuels to produce electricity. The oxygen required for a fuel cell usually comes from the air, for instance, by pumping air into the cathode. Hydrogen, however, is not so readily available and has limitations that make it impractical as a fuel source for fuel cells. For instance, hydrogen is difficult to store and distribute.

When considering fuel cells as a viable alternative to the internal combustion engine, the choice of fuel needs to be considered carefully. Ideally, a fuel cell is run with pure hydrogen as its fuel source. However, the storing and transportation of compressed hydrogen in automobiles raises safety concerns and the lack of commercial distribution severely limits the commercial viability of hydrogen fuel cells.

Proposed alternatives to pure hydrogen as a fuel is the reformation, either directly or indirectly, of hydrogen rich fuel such as methanol, ethanol, propane and methane. Similarly, alternative fuel sources may be produced by gasification of a biomass, such as coal, wood, charcoal, and corn husks. These fuels can be converted into hydrogen with by-products of carbon dioxide, water, and trace amounts of carbon monoxide. The platinum catalyst of the fuel cell has little tolerance to carbon monoxide (CO), however, and is quickly poisoned and passivated in the presence of even small quantities of carbon monoxide (<100 ppm), requiring the addition of preferential oxidation reactors to remove CO from the reformate fuel stream prior to reaching the anode. Such procedures add to the overall cost, size, complexity, and parasitic power drain of an inclusive power plant.

One method of reforming such fuels is endothermic steam reforming. This type of reforming combines the fuels with steam by vaporizing them together at high temperatures. Hydrogen is then separated out using membranes. Another type of reformer is the partial oxidation (PDX) reformer.

Methanol (CH₃OH), for instance, has been investigated as a possible fuel source. The goal of the reformer is to remove as much of the hydrogen as possible, while minimizing the emission of pollutants such as carbon monoxide. The process starts with the vaporization of liquid methanol and water. Heat produced in the reforming process is used to accomplish this. This mixture of methanol and water vapor is passed through a heated chamber that contains a catalyst.

As the methanol molecules hit the catalyst, they split into carbon monoxide (CO) and hydrogen gas (H₂):

CH₃OH=>CO+2H₂

The water vapor splits into hydrogen gas and oxygen; this oxygen combines with some of the CO to form CO₂.

H₂O+CO =>CO₂+H₂

Similarly, natural gas, has been used to produce reformate fuels. Natural gas, which is composed mostly of methane (CH₄), is processed in a manner similar to methanol. The methane in the natural gas reacts with water vapor to form carbon monoxide and hydrogen gases.

CH₄+H₂O=>CO+3H₂

Just as it does when reforming methanol, the water vapor splits into hydrogen gas and oxygen, the oxygen combining with the CO to form CO₂.

H₂O+CO=>CO₂+H₂

Neither of these reactions are perfect, however; some methanol or natural gas and carbon monoxide pass through the reformer without reacting. Such contaminants lower the performance of the fuel cell. For instance, as discussed above, carbon monoxide passivates metal catalysts commonly used in fuel cells, such as platinum and palladium.

Therefore, attempts have been made to remove carbon monoxide from the reformate fuel stream. For instance, U.S. Pat. Nos. 4,910,099 and 5,482,680 disclose methods for oxidizing carbon monoxide present in the reformate fuel stream. Even utilizing such techniques, however, fuel cells continue to operate at significantly reduced performance due to carbon monoxide passivation.

The above described fuel cells, however, suffer from one or more problems and/or disadvantages that limit their applicability and/or commercial potential. For instance, state-of-the-art fuel cells that use reformers typically require substantial hardware to sustain fuel cell operation. This includes various devices to treat the reformate fuel stream in an attempt to remove undesirable components, such as carbon monoxide. Such hardware complicates and dramatically increases the weight and cost of fuel cell systems.

Accordingly, there remains a need in the art for methods to improve the performance of fuel cells employing reformate fuels.

It has been found, according to the present invention, that the performance of fuel cells employing a reformate fuel stream may be unexpectedly improved by employing a magnetically modified fuel cell and incorporating oxygen into the reformate fuel stream. Such systems result in significantly improved performance.

### SUMMARY OF THE INVENTION

An object of the present invention is to solve at least the problems and/or disadvantages described above and to provide at least the advantages described hereinafter.

Another object of the present invention is to provide methods for improving performance of magnetically modified fuel cells.

Still another object of the present invention is to improve carbon monoxide tolerance of magnetically modified fuel cells.

In accordance with these and other objects, a first embodiment of the present invention is directed to a method for improving performance of a magnetically modified fuel cell comprising an anode, a cathode and a polymer electrolyte membrane therebetween, said method comprising contacting said anode with a reformate fuel stream that contains an amount of oxygen effective to increase carbon monoxide tolerance of said fuel cell, wherein each of said anode and said cathode independently comprises an electrically conducting material having a catalytic material on at least a portion of a first surface thereof and further wherein each of said catalytic materials independently comprises an effective amount of at least one catalyst.

Additional advantages, objects and feature of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF DRAWINGS

The invention will be described in detail with reference, at least in part, to the following drawings in which like reference numerals refer to like elements wherein:

FIGS. 1 and 2 are schematic cross-sections of a fuel cell having features of the present invention.

FIG. 3 illustrates a CO oxidation profiles at various particle/Nafion modified platinum electrodes with a particle volume loading of 15% in a CO saturated 0.1 M Na₂SO₄ solution.

FIG. 4 shows a graph of the CO oxidation peak position at the more negative potential for the magnetically modified electrodes in FIG. 1 versus that of the CO oxidation at a non-magnetically modified electrode as a function of magnetic field strength of the modifying particles.

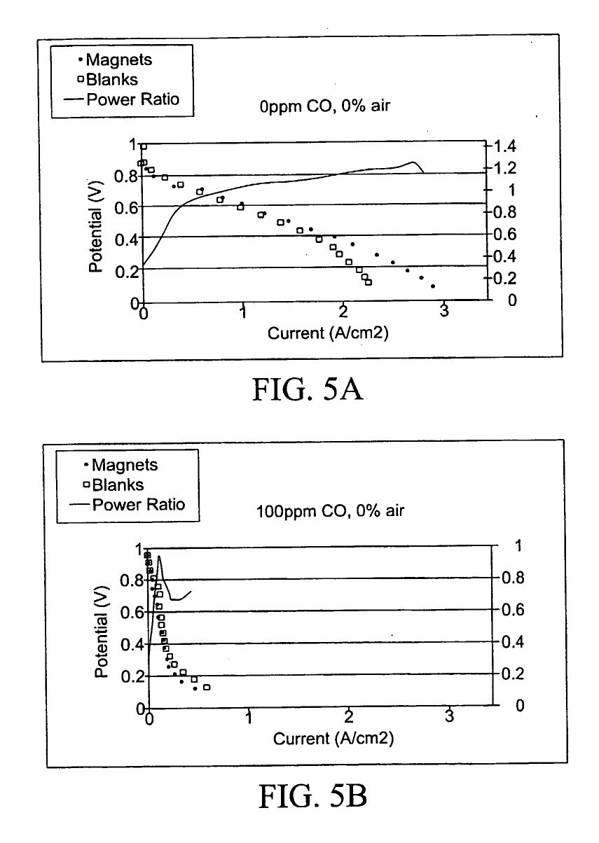

FIGS. 5A-5C shows a comparison of current voltage and power ratio curves of magnetic and nonmagnetic PEFCs operating with no CO and air bleed, with 100 ppm CO and no air bleed, 100 ppm CO and 1% air bleed.

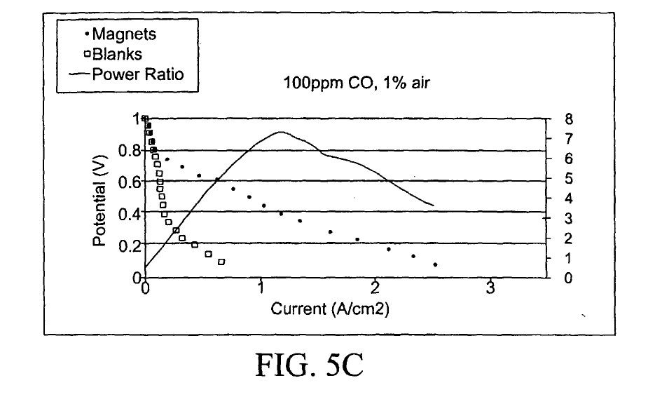

### DETAILED DESCRIPTION OF PREFERRED EMBODIMENTS

Unless otherwise stated, a reference to a compound or component includes the compound or component by itself, as well as in combination with other compounds or components, such as mixtures of compounds and/or components.

As used herein, the singular forms “a,” “an,” and “the” include the plural reference unless the context clearly dictates otherwise.

As used herein, the term “within the vicinity of the particle” is intended to mean sufficiently close to the particle for it to exert its effect(s) on the reactant(s) and/or product(s) involved in the relevant chemical reaction. Such distances will therefore vary depending, for example, on the nature of the particle, including its composition and size, and, where appropriate, the strength of the magnetic field, as well as the reactant(s) involved in the affected chemical reaction and the product(s) yielded.

As used herein, the term “catalytic material” is intended to mean the substance(s) found on the surface of a cathode or anode in a fuel cell responsible for the chemical reaction(s) involved in the production of electrical power and the transfer of that power (e.g., in the form of subatomic particles such as electrons or protons) from the site of the chemical reaction(s). Thus, as used herein, a “catalytic material” contains at least one “catalyst component” (the substance or a component thereof that catalyzes the relevant chemical reaction(s) involved) and may also contain at least one ion or electron conducting material. The “catalytic material” may also contain other components, such as a modifying material, which is not directly involved in the chemical reaction(s), or magnetic and/or magnetizable particles, which may or may not be directly involved in the chemical reaction(s).

As used herein, the term “modifying material” is intended to mean a material that affects at least one of the following properties of a substance: hydrophilicity, hydrophobicity, organophobicity, organophilicity, surface charge, dielectric constant, porosity, gas exclusion, gas permeability, deliquescence, wetting, density, electron conductivity and ionic conductivity.

As used herein, the term “to increase carbon monoxide tolerance” is intended to mean that the performance of the magnetically modified fuel cell is improved compared to a similar fuel cell wherein the reformate fuel stream does not contain oxygen per se or a source of oxygen, such as air.

As used herein, the term “magnetically modified fuel cell” is intended to mean a fuel cell in which the anode and/or cathode has been magnetically magnified, for instance, by incorporation of magnetic materials. Such fuel cells are disclosed, for instance, in copending U.S. patent application Ser. No. 10/684,802, the disclosure of which is herein incorporated by reference in its entirety.

A first preferred embodiment of the present invention is directed to a method for improving performance of a magnetically modified fuel cell comprising an anode, a cathode and a polymer electrolyte membrane therebetween, said method comprising contacting said anode with a reformate fuel stream that contains an amount of oxygen effective to increase carbon monoxide tolerance of said fuel cell, wherein each of said anode and said cathode independently comprises an electrically conducting material having a catalytic material on at least a portion of a first surface thereof and further wherein each of said catalytic materials independently comprises an effective amount of at least one catalyst.

The effective amount of catalyst component present in the catalytic material on the cathode may vary from application to application depending upon factors such as the particular fuel employed and the particular composition of the catalytic material, including the particular catalyst component(s) present, as well as any other ingredients. Accordingly, suitable amounts of catalytic component(s) for the catalytic material on the anode (and the cathode) in a given membrane electrode assembly may be determined empirically by one skilled in the art. By way of illustration, when platinum is employed as the catalyst component, it may be present in the catalytic material in an amount as little as 0.1 mg/cm² up to an amount well in excess of 1 mg/cm².

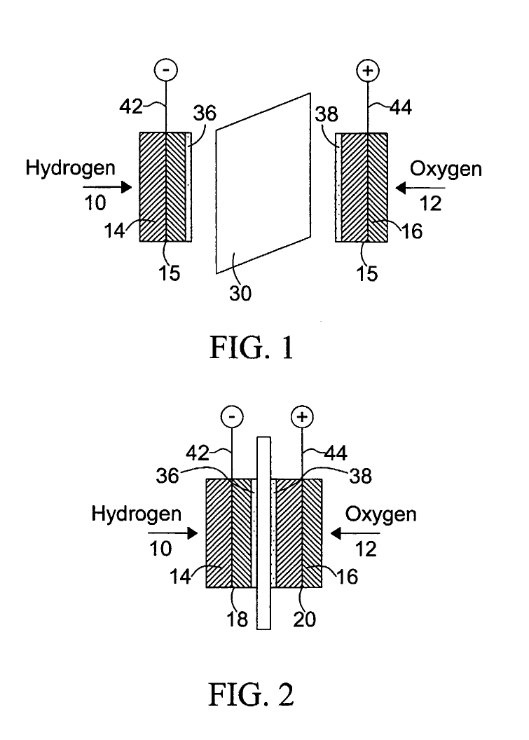

Referring to FIGS. 1 and 2, a schematic cross-section is shown of a magnetically modified fuel cell having features of the present invention. A fuel cell as shown includes a reformate fuel stream as a fuel source (10). Optionally, the fuel cell may contain an oxidizer source (12). These gaseous reactants diffuse through (optional) backing layers (14) and (16), respectively, to an anode (an oxidizing electrode) (18) and a cathode (a reducing electrode) (20). Anode connection (42) and cathode connection (44) are used to interconnect with an external circuit (not shown in figure) or with other fuel cell assemblies. According to the present invention, the fuel is magnetically modified by incorporating magnetic and/or magnetizable particles into the anode and/or cathode.

Anode (18) and cathode (20) each comprise an electrically conducting material. Illustrative examples of suitable conductive materials include, but are not limited to, the following: metals; carbon, such as graphite; semiconductors; semimetals; magnetic materials; and combinations of two or more thereof. Illustrative examples of suitable metals for use as the conductive material include transition metals, such as Ni, Fe, Zn or Cd, and precious metals, such as Ag, Au, Pt, Ir, Ru, Rh, Os, and Ir. Particularly preferred metals for use as the conductive material include platinum and composites of platinum, such as platinum-ruthenium composites.

Additionally, the conductive material may comprise a mixture of two or more metals, or a metal and a non-metal, such as a polymeric material. Other suitable conductive materials for use as the conductive material in the membrane electrode assemblies according to the present invention include a matrix, e.g., metal matrix, including magnetic particles or magnetic components.

The conductive material may be continuous with no openings therein, such as a rod, foil or sheet, or may be configured to have openings therein, such as a mesh or screen. The conductive material can have any geometrical shape suitable for a predetermined use. Non-limiting examples of such geometries include rods (hollow or solid), circles, squares, triangles, rectangles, and the like.

According to the various embodiments of the present invention, the anode (18) and cathode (20) each have a catalytic material on at least a portion of the surface thereof. The catalytic material on the anode may be the same as the catalytic material on the cathode, or it may be different. According to certain preferred embodiments, the anode (18) and cathode (20) each have a thin layer of said catalytic material (36) and (38), respectively, covering substantially the entire surface thereof adjacent to the PEM. Again, each layer may comprise the same catalytic material(s) or different catalytic materials.

Each catalytic material layer contains an effective amount of at least one catalyst component. Various catalyst components are suitable for use in the catalytic material. These catalyst components include, but are not limited to, iridium, platinum, palladium, gold, silver, copper, nickel, iron, osmium, ruthenium, cobalt, molybdenum, tin and various alloys of these materials, as well as combinations of these materials and/or alloys thereof. Other suitable catalyst components include, but are not limited to, suitable non-metals, such as electronically conducting mixed oxides with, for example, a spinel or perovskite structure. According to a particularly preferred specific embodiment, the catalytic material (36) on the anode (18) comprises platinum, and the catalytic material (38) on the cathode (20) comprises either platinum or another oxygen-reducing catalyst (for example, a macrocyclic chelate compound).

The amount of catalyst component(s) present in the catalytic material will vary depending upon the particular catalyst component(s) selected, the gaseous reactants involved and the like. Suitable amounts of catalyst component for a particular membrane electrode assembly may therefore be determined empirically by one skilled in the art. By way of illustration and not of limitation, if for example, the catalyst component on the cathode and/or anode is platinum, then it may preferably be present in any amount from 0.1 mg/cm² up to 1 mg/cm² or even several mg/cm² and more preferably in an amount of about 0.1 mg/cm² to about 0.5 mg/cm², such as about 0.3 mg/cm² to about 0.4 mg/cm².

In addition to the catalyst component or components, the catalytic material may also further comprise at least one ion conducting material. Suitable ion conducting materials are known and available to those skilled in the art. Illustrative examples of such ion conducting materials include, but are not limited to, polymers generally useful in polymer electrolyte membranes. Particularly preferred ion conducting materials include perfluorinated sulfonic acid polymers, such as the material known under the trademark Nafion and available from E.I. DuPont de Nemours or Ion Power, Inc. The ion conductor may be formed of ion conductor supported on a nonconducting or lower conducting porous support. A most preferred ion conducting material for use in various embodiments of the present invention is Nafion 1100. According to certain very preferred embodiments, the ion conducting material in the catalytic material on the cathode and the anode is the same as the ion conducting material of the PEM.

The amount of ion conducting material present in the catalytic material will vary depending upon the particular ion conducting material employed, the other components of the membrane electrode assembly, the gaseous reactants involved and the like. Suitable amounts of ion conducting material for a particular membrane electrode assembly may therefore be determined empirically by one skilled in the art. By way of illustration and not of limitation, if, for example, the ion conducting material in the catalytic material on the cathode and/or anode is Nafion, then it may be present in an amount of about 5-35 dry wt % of the (dry) catalyst material layer, preferably about 30 dry wt %.

The catalytic material may also further comprise at least one modifying material in addition to the catalyst component(s) and, if present, the ion conducting material. The modifying material affects at least one chemical or physical property of the catalytic material, including, but not limited to, the following: hydrophilicity, hydrophobicity, organophilicity, organophobicity, surface charge, dielectric constant, porosity, gas exclusion, gas permeability, deliquescence, wetting, density, electron conductivity and ionic conductivity.

Suitable modifying materials are known and available to those skilled in the art. Illustrative examples of suitable modifying materials include, but are not limited to, polyalkylenes and derivatives thereof, such as partially or fully fluorinated polyalkylenes (e.g., Teflon). A particularly preferred polyalkylene for use in certain embodiments of the present invention, such as membrane electrode assemblies that employ perfluorinated sulfonic acid polymers (e.g., Nafion) as the ion conducting material, is polyethylene.

According to other preferred embodiments of the present invention, the modifying material may be a hydrophilic material, such as poly hydroxy methacrylate, that improves the interfacial humidification of the membrane electrode assembly.

The amount of modifying material present in the catalytic material will vary depending upon the particular components of the membrane electrode assembly, the gaseous reactants involved and the like. Suitable amounts of modifying material for a particular membrane electrode assembly may therefore be determined empirically by one skilled in the art.

The catalytic material may also further comprise a plurality of magnetic particles and/or magnetizable particles.

In those embodiments of the present invention in which magnetic particles are present, the particles each possess a magnetic field of sufficient strength to alter the rate of and/or distribution of products resulting from a chemical reaction involving the particle or occurring within the vicinity of the particle. Such a chemical reaction may involve mass transport, transfer of subatomic particles (e.g., electrons and protons) and/or flux of a solute.

In those embodiments of the present invention in which magnetizable particles are present, the particles have been exposed to a magnetic field of sufficient strength for a sufficient time to align the magnetic moments of at least a portion of the atoms (preferably a majority and even more preferably a substantial majority) within at least a portion of the particles (and preferably a majority and even more preferably a substantial majority thereof). According to these embodiments of the present invention, the portion of atoms aligned within a given particle is sufficient to alter the rate of and/or distribution of products resulting from a chemical reaction involving the particle or occurring within the vicinity of the particle. Preferably, the alignment of atoms is maintained upon removal of the magnetic field, but this is not required (for example, in the case of superparamagnetic materials). Such a chemical reaction may involve mass transport, transfer of subatomic particles (e.g., electrons and protons) and/or flux of a solute.

The magnetizable particles may be subjected to a magnetic field before, during, and/or after incorporation into the magnetically modified fuel cells. The magnetic field may be applied, for instance, by use of a permanent magnet or an electromagnet. For instance, a magnet may be brought near or in contact with the particles or immersed into a container holding the particles. Preferably, the magnetic field strength is slightly stronger than the saturation magnetization of the particles, although weaker fields can also be employed. Illustrative examples of suitable field strengths are in the range of about 0.05 to about 2.0 T, preferably about 0.1 to about 1.0 T, and more preferably about 0.2 to about 0.5 T.

Examples of suitable materials for use as particles in the fuel cells of the present invention include, but are not limited to, the following: permanent magnetic materials, paramagnetic materials, superparamagnetic materials, ferromagnetic materials, ferrimagnetic materials, superconducting materials, anti-ferromagnetic materials, mu metals, and combinations thereof.

According to certain embodiments of the present invention, the particles may comprise a permanent magnetic material. Suitable permanent magnetic materials are known and available to those skilled in the art. Illustrative examples of suitable permanent magnetic materials include, but are not limited to, samarium cobalt, neodynium-iron-boron, aluminum-nickel-cobalt, iron, iron oxide, cobalt, misch metal, ceramic magnets comprising barium ferrite and/or strontium ferrite, and mixtures thereof.

According to other embodiments of the present invention, the particles may comprise a paramagnetic material. Suitable paramagnetic materials are known and available to those skilled in the art. Illustrative examples of suitable paramagnetic materials include, but are not limited to, aluminum, stainless steel, gadolinium, chromium, nickel, copper, iron, manganese, and mixtures thereof.

According to still other embodiments of the present invention, the particles may comprise a superparamagnetic material. Suitable superparamagnetic materials are known and available to those skilled in the art.

According to still other embodiments of the present invention, the particles may comprise a ferromagnetic material. Suitable ferromagnetic materials are known and available to those skilled in the art. Illustrative examples of suitable ferromagnetic materials include, but are not limited to, Ni—Fe alloys, iron, and combinations thereof.

According to still other embodiments of the present invention, the particles may comprise a ferrimag-netic material. Suitable ferrimagnetic materials are known and available to those skilled in the art. Illustrative examples of suitable ferrimagnetic materials include, but are not limited to, rare earth transition metals, ferrite, gadolinium, terbium, and dysprosium with at least one of Fe and Co, and combinations thereof.

According to still other embodiments of the present invention, the particles may comprise a superconducting material. Suitable superconducting materials are known and available to those skilled in the art. Illustrative examples of suitable superconducting materials include, but are not limited to, niobium titanium, yttrium barium copper oxide, thallium barium calcium copper oxide, bismuth strontium calcium copper oxide, and combinations thereof.

According to still other embodiments of the present invention, the particles comprise an anti-ferromagnetic material. Suitable anti-ferromagnetic materials are known and available to those skilled in the art. Illustrative examples of suitable anti-ferromagnetic materials include, but are not limited to, FeMn, IrMn, PtMn, PtPdMn, RuRhMn, and combinations thereof.

Other suitable particles which may be used in the membrane electrode assemblies according to the present invention include AB₅ alloys, such as La_{0.9}Sm_{0.1}Ni_{2.0}Co_{3.0}, and AB₂ alloys, such as Ti_{0.51}Zr_{0.49}V_{0.7}Ni_{1.18}Cr_{0.12} or MmNi_{3.2}Co_{1.0}Mn_{0.6}Al_{0.2}, where Mm is misch metal (25 wt % La, 50 wt % Ce, 7 wt % Pr, and 18 wt % Nd). Such materials can be used alone or in combination. Thus, the catalytic material may include stoichiometric particles, such as Sm₂CO₇ or Fe₃O₄, or non-stoichiometric particles, such as La_{0.9}Sm_{0.1}Ni_{2.0}Cu_{3.0}, or a combination thereof.

In addition to or in place of the above materials, the particles may comprise a ceramic magnet. Examples of suitable ceramic magnets include, but are not limited to, those made of barium ferrite and/or strontium ferrite.

The amount of magnetic particles and/or magnetizable particles may vary depending upon the particular material present in the particles, the strength of the magnetic field, the other components of the catalytic material and the like. Suitable amounts of magnetic particles and/or magnetizable particles may therefore be determined empirically by one skilled in the art. By way of illustration, magnetic particles and/or magnetizable particles may be present in the catalytic material in an amount 0.1 mg/cm² up to 1.0 mg/cm², and more preferably in an amount of about 0.1 mg/cm² to about 0.4 mg/cm², such as about 0.1 mg/cm² to about 0.2 mg/cm².

According to certain preferred embodiments of the present invention, at least a portion of the particles present in the catalytic material are coated with one or more coating layers. For instance, each of the particles may have one coating layer or a plurality of coating layers on at least a portion of their surface. According to such particularly preferred embodiments, the particles have a coating of an inert material and a coating of a modifying material.

When the magnetic particles and/or magnetizable particles are coated with a modifying material, then the particles may be present in the catalytic material in an amount 0.1 mg/cm² up to 1 mg/cm², and more preferably in an amount of about 0.1 mg/cm² to about 0.8 mg/cm², such as about 0.3 mg/cm² to about 0.4 mg/cm².

Suitable inert materials for coating the particles include any materials that do not adversely interact with the environment in which the particles are used. Such coatings can be used, for instance, to protect the particles from the corrosive effects of solvents. Thus, coatings of suitable inert materials render the particle(s) chemically inert and/or mechanically stable. Suitable inert materials are known and available to those skilled in the art.

Preferably, the inert material used to coat the particles is a silane or silicon dioxide. Particularly preferred such coatings include, but are not limited to, trialkoxysilanes, such as 3-aminopropyltrimethoxysilane. By way of illustration and not limitation, if the particles are Fe₃O₄, the coating is preferably a silane or silicon dioxide coating prepared via ethanol reduction of tetraethylorthosilicate. Suitable coated particles can be made as disclosed in WO 01/99127, the disclosure of which is herein incorporated by reference in its entirety.

In addition to the inert material, the particles may also have a coating of a modifying material. The modifying material affects at least one chemical or physical property of the particle, including, but not limited to, the following: hydrophilicity, hydrophobicity, organophilicity, organophobicity, surface charge, dielectric constant, porosity, gas exclusion, gas permeability, deliquescence, wetting, density, electron conductivity and ionic conductivity.

Suitable modifying materials are known and available to those skilled in the art. Particularly preferred modifying materials are those that improve the water concentration about the particle(s) and any nearby catalyst component(s) and/or local ionic conductivity. Illustrative examples of suitable modifying materials include, but are not limited to, homopolymers formed from the following monomers: styrene, styrene derivatives, 2-hydroxyethyl acrylate, 2-hydroxyethyl methacrylate, iso-decyl methacrylate, methyl methacrylate, methyl acrylate, vinyl acetate, ethylene glycol, ethylene, 1,3-dienes, vinyl halides, and vinyl esters.

Further illustrative examples of suitable modifying materials include, but are not limited to, copolymers formed from at least one Monomer A and at least one Monomer B. Examples of Monomer A include, but are not limited to, styrene, methyl acrylate, iso-decyl methacrylate, 2-hydroxyethyl acrylate, and 2-hydroxyethyl methacrylate. Examples of Monomer B include, but are not limited to, 4-styrenesulfonic acid and ethylene glycol dimethacrylate.

While the size of the particles is not particularly limited, in certain embodiments, the particles preferably have sizes ranging from about 0.1 microns to about 15 microns, such as about 0.1 to about 10 microns, about 0.5 to about 10 microns, about 2 microns to about 8 microns, or about 3 microns to about 6 microns.

The PEM (30) separates the anode (18) from the cathode (20). Preferably, a fluorine-containing solid polymer is employed as the polymer electrolyte membrane.

According to one particularly preferred embodiment of the present invention, one or more perfluorinated sulfonic acid polymers, such as the material known under the trademark Nafion and available from E.I. DuPont de Nemours or Ion Power, Inc., is used as the PEM (30). The use of Nafion as a solid polymer electrolyte membrane is more particularly described in U.S. Pat. No. 4,469,579, the disclosure of which is incorporated herein by reference.

Nonetheless, any polymer that could be used as an electrolyte membrane in a solid polymer fuel cell, such as the perfluorocarbon polymers made by Dow Chemicals Company, is equally suitable as the PEM (30). Indeed, any fluoropolymer that is known to be useful as an electrolyte membrane in a fuel cell may be employed as the PEM (30) in the inventive membrane electrode assemblies. Moreover, the polymer employed as the PEM (30) may be the same as or different from the ion conducting material(s) in the catalytic material layer.

The PEM should be of sufficient thickness to limit reactant crossovers through the anode and the cathode. By way of example and not limitation, in one preferred embodiment the present invention, the PEM (30) is a Nafion membrane, such as Nafion 1100, having a suitable thickness.

According to preferred embodiments of the present invention, the PEM generally has a maximum thickness of less than 20 mils. Preferably, the PEM has a maximum thickness of less than or equal to about 10 mils, more preferably less than about 7 mils, even more preferably less than about 5 mils and most preferably less than about 2 mils. According to still other preferred embodiments of the present invention, the PEM has a maximum thickness between about 1 mil and about 7 mils. Moreover, the PEM (30) may also be composed of a plurality of very thin layers, e.g., less than one micron (1 μm) in thickness, each of which may be the same or different.

According to preferred embodiments of the present invention, the PEM is subjected to at least one modifying process prior to inclusion in the inventive membrane electrode assemblies. Such a modifying process may affect at least one chemical or physical property of the particle, including, but not limited to, the following: hydrophilicity, hydrophobicity, organophilicity, organophobicity, surface charge, dielectric constant, porosity, gas exclusion, gas permeability, deliquescence, wetting, density, electron conductivity and ionic conductivity. Preferably, the modifying process(es) enhance hydration of the PEM and/or reduce the maximum thickness of the PEM. Suitable modifying processes are known to those skilled in the art.

By way of illustration, when a Nafion polymer electrolyte membrane (such as those available from Ion Power, Inc.) is employed as the PEM, a particularly preferred modifying process involves contacting the membrane with an acidic solution at elevated temperature for a sufficient period of time. For example, a 50 micron thick membrane composed of Nafion 1100 is preferably contacted with a 50% aqueous solution of sulfuric acid at 90° C. for two hours prior to incorporation into a membrane electrode assembly of the present invention.

Suitable fuel sources (10) that may be used in conjunction with the methods of the present invention are reformate fuels. Non-limiting examples of reformate fuels include, but are not limited to methanol, ethanol, propane, and methane. Alternatively, the reformate fuel may be derived from gasification of a biomass, such as coal, wood, charcoal, corn husks, and coconut husks. Combinations of one or more fuels may be employed. Reformate fuel streams suitable for practicing the present invention are formed by methods known in the art, such as steam reformation.

According to the methods of the present invention, an amount of oxygen effective to increase carbon monoxide tolerance of the fuel cell is added to the reformate fuel stream contacting the anode. The oxygen may be provided as air or gaseous O₂ gas. In certain preferred embodiments of the present invention, the oxygen is provided as air. The oxygen may be added upstream from the fuel cell, at the anode interface or a combination thereof.

Suitable amounts of oxygen according to the present invention are those amounts effective to increase performance of the fuel cell, for instance, by improving carbon monoxide tolerance. According to certain preferred embodiments of the present invention, the reformate fuel stream preferably contains 0.50% to 2.50% oxygen, more preferably 1.00% to 2.00% oxygen, and still more preferably 1.00% to 1.50% oxygen. It particularly preferred embodiments of the present invention, the reformate fuel stream contains 0.50% to 2.50% air, more preferably 1.00% to 2.00% air, and still more preferably 1.00% to 1.50% air. Preferably, the reformate fuel stream contains about 1.00% oxygen and more preferably about 1.00% air.

A suitable magnetically modified fuel cell having the features of the present invention may be prepared according to any of the methods and techniques known to those skilled in the art. For example, a magnetically modified fuel cell may be prepared by putting the components shown in FIG. 1 together and pressing under appropriate conditions, such as under a pressure of about 400 lbs/in² at a temperature of about 130° C., for a suitable period of time, such as about 3 minutes. The temperature and pressure conditions selected should ensure that the two electrodes (18) and (20) are in good contact with the PEM (30) and precise conditions may be determined empirically by one skilled in the art.

### Example

### A. Magnetic Particles

While the self-hydrating MEAs of the present invention function without magnetic modification, the power output of the cells increases at low temperatures (25° C. and 37° C.) with magnetic modification. Two types of Fe₃O₄ microparticles were employed, each type having two coatings: an inner inert coating of a silane or silicon dioxide and an outer modifying coating of either polystyrene-poly(4-styrene sulfonic acid) copolymer or poly(2-hydroxyethyl acrylate).

The modifying coating was added to silane or silicon dioxide coated particles (prepared via an ethanol reduction of tetraethyl orthosilicate) by the following procedure:

(1) The following solution was added to a 500 ml, 24-40, 3-neck flask in a constant temperature bath: (a) 150 ml ethanol; (b) 62.5 ml 2-methoxyethanol; and (c) 3.75 g (1.5% w/v of total solution) polyvinylpyrrolidone with MW of 10,000.

(2) 1.5 g of SiO₂ coated magnetic particles (2-5 microns in diameter) were added.

(3) The solution was stirred vigorously using an overhead stirrer (Teflon stir blade, 10 mm glass rod, glass bearing ad a variable speed drill controlled by a variable AC resistor).

(4) The solution temperature was increased to 73° C. and allowed to equilibrate for one hour.

(5) A solution of monomer and initiator was then added: (a) 1.5 g (0.6% w/v of total solution volume) benzoyl peroxide; (b) 35.0 g (16% w/v of total solution volume) styrene; and (c) 0.75 g of (4-styrene sulfonic acid) sodium salt, or (a) 2.143 g t-butyl hydroperoxide solution (70 wt % in water); and (b) 30.0 g of 2-hydroxyethyl acrylate.

(6) The suspension was stirred at 73° C. for 24 hours.

(7) The polymer reaction was quenched by reducing the temperature to 5° C. for 1 hour.

(8) The particles were separated and washed with ethanol and then distilled water, and then dried at 80° C.

The particles can be subjected to a magnetic field at any time before, during and/or after the above processing.

### B. Electrode Preparation

Catalytic ink formulation and production—Due to the coating of the catalytic ink on the inside of the mixing container, an excess of 10 fold for one electrode was prepared in order to ensure a proper mix and that there was an adequate supply of ink to coat both the anode and the cathode electrodes gas diffusion layer (GDL). The formulation of enough ink to coat 50 cm² of electrodes and with a Pt and magnetic loading of 0.4 mg/cm² follows: (1) 0.100 g Alfa Aesar 20% Pt on carbon support; (2) 1.200 g of Liquion-1100 (5 wt % Nafion 1100 EW solution); (3) 1.100 g of de-ionized water; and (4) 0.040 of polymer coated magnetic particles.

To aid in the mixing of the catalytic ink, two 10 mm and one 5 mm aluminum oxide spheres were added to the formulation. The container used to mix the ink was a 30 ml Nalgene high density polyethylene bottle with a screw top lid that was sealed with Parafilm prior to mixing. The ink was mixed using a ⅜″ variable speed drill with input power controlled by a variable alternating current resistor. The mixing container was attached substantially parallel to the axis of the chuck of the drill (preferably at a slightly offset angle) using a buret clamp. One end of the clamp was inserted into to chuck of the drill and the other end was clamped to the top of the bottle where the length of the bottle was substantially (but not exactly) parallel to the shaft of the buret clamp. The mix was rotated at 80% full power, 2000 rpm, for 30 sec. behind a Plexiglas safety shield.

Catalytic ink painting—Two double-sided ELAT carbon cloth (E-Tek) electrodes were cut so that the resulting electrode was substantially square with an area of about 5 cm². 1/10 of the ink formulation prepared above was then applied to the electrode in two steps. First, a thin layer of ink was painted onto the electrode surface using a short bristle brush. Second, the remainder of the ink was pipetted onto the electrode surface having the thin layer of painted ink, and the electrode tilted repeatedly until the ink substantially uniformly covered the electrode surface. The electrodes were allowed to dry in a fume hood until visibly dry, followed by final drying under vacuum (40 mTorr) for about two hours at ambient temperature.

### C. Lamination

The lamination of the MEA was a hot-press of the following stack (top to bottom): (1) Furon, 5″×5″×0.015″; (2) Teflon, 45 mm×45 mm×0.062″; (3) Kapton, 5″×5″×0.002″; (4) electrode, catalytic material layer face down; (5) Nafion membrane; (6) electrode, catalytic material layer face up; (7) Kapton, 5″×5″×0.002″; (8) Teflon, 45 mm×45 mm×0.062″; and Furon, 5″×5″×0.015″.

The above stack was placed between two temperature-controlled platens of a hydraulic press (15 ton Carver with thermostatically controlled platens). The platens were brought together until the pressure started to increase and the temperature of both platens was set to 128° C. With this press, the temperature ramp takes about 20 min. When the platens reached the desired temperature, the pressure was increased to 0.25 metric tons and held there for three minutes. The pressure was then decreased to that equal to the pressure are the start of the temperature ramp, and the temperature is reduced to 25° C. The Furon, Teflon and Kapton layers were then removed using de-ionized water from a squirt bottle.

### D. Fuel Cell Performance

Enhanced performance of fuel cells containing PEMs operating on a synthetic reformate fuel containing 100 ppm of CO when the anodes are modified with polymer shrouded magnetic microparticles. Cyclic voltammetric studies that were taken during studies of magnetic field effects on CO oxidation at magnetically modified Pt electrodes show the effects of magnetic fields on CO oxidation as compared to nonmagnetic Pt electrodes (FIG. 1).

These studies show the oxidation of CO is further facilitated by the addition of stronger magnetic materials. Samarium cobalt and two types of neodymium iron boron magnets were used; their maximum energy products are 17 MGOe, 37 MGOe and 9.8 MGOe, respectively. The maximum energy product for magnetite is 5 MGOe. For the NdFeB magnets, the oxidation wave for CO is shifted about 600 mV negative of its value at a nonmagnetic electrode. The peak potential for the oxidation of CO shifts linearly with maximum energy product, as shown in FIG. 2.

The stronger the magnetic material, the more effective the catalyst at oxidizing CO. Fuel cells not containing oxygen in the fuel stream showed a small fraction of the CO tolerance compared to fuel cells containing oxygen in the fuel stream. Results show that introducing a small amount of air, about 1%, into the synthetic reformate stream containing 100 ppm CO resulted in a relatively small, 30%, decrease in performance, when compared to the same cell operating with no CO, in the 0.7 to 0.8 V region of the power curve for magnetically modified cells. Non-magnetically modified cells decreased in performance between 70 and 85% when compared to the same cell operating with no CO.

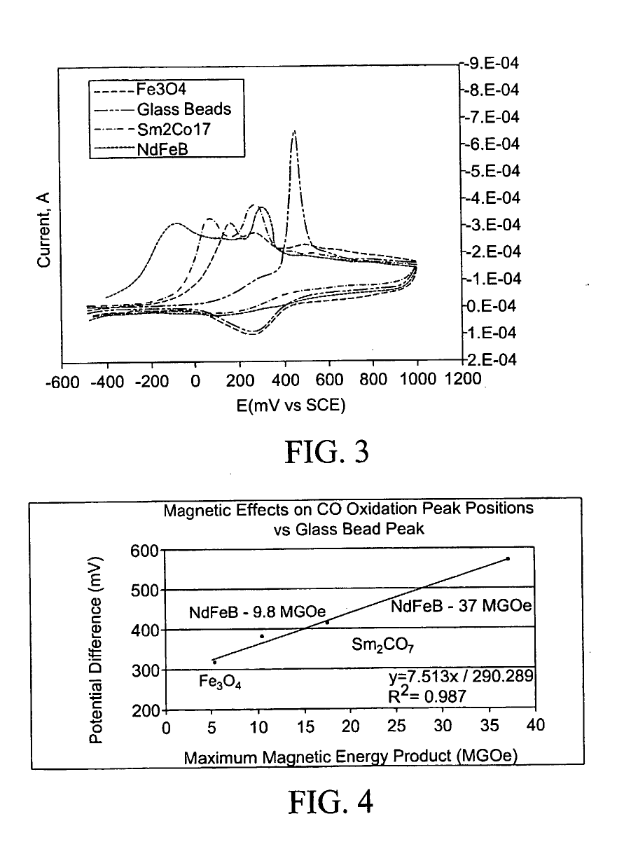

Current/voltage curves comparing magnetically and non-magnetically modified operating without CO and oxygen in the fuel stream, with 100 ppm CO without an air bleed, and with 100 ppm CO with a 1% air bleed are shown in FIG. 3. A statistical comparison of current densities at practical potentials for both types of cells with an average of at least 3 data series of each type is shown in Tables 1 and 2. It was found the maximum CO tolerance can be achieved with a 1% air bleed for both the Fe₃O₄ and Al₂O₃ modified cells.

TABLE 1
Summary of current density and open circuit potentials of magnetically
modified PEFCs as a function of CO exposure and percentage anode air bleed.
Catalyst and magnetic loading are approximately 0.4 mg/cm² Pt and 0.4 mg/cm²
poly(4-stryenesulfonic acid)-polystyrene copolymer coated Fe₃O₄. Number of
replicates given as n.

| % Air bleed and | Current Density (A/cm2) | | | | |
|---|---|---|---|---|---|
| CO concentration | 0.800 V | 0.700 V | 0.500 V | N | Open Circuit (V) |
| 0% air, 0 ppm CO | 0.188 ± 0.084 | | 0.541 ± 0.196 | 13 | 0.962 ± 0.013 |
| 0% air, 100 ppm | | 1.368 ± 0.328 | | 3 | 0.925 ± 0.009 |
| CO | 0.015 ± 0.002 | | 0.035 ± 0.005 | 3 | 0.953 ± 0.006 |
| 0.50 % air, 100 ppm | | 0.056 ± 0.007 | | 5 | 0.953 ± 0.004 |
| CO | 0.070 ± 0.003 | | 0.253 ± 0.005 | 3 | 0.958 ± 0.009 |
| 1.00 % air, 100 ppm | | 0.559 ± 0.023 | | 5 | 0.956 ± 0.009 |
| CO | 1.132 ± 0.054 | | 0.359 ± 0.093 | 3 | 0.958 ± 0.009 |
| 1.50 % air, 100 ppm | | 0.885 ± 0.147 | | | |
| CO | 0.061 ± 0.012 | | 0.235 ± 0.023 | | |
| 2.00 % air, 100 ppm | | 0.528 ± 0.019 | | | |
| CO | 0.048 ± 0.008 | | 0.237 ± 0.025 | | |
| 2.50 % air, 100 ppm | | 0.742 ± 0.011 | | | |
| CO | 0.062 ± 0.008 | | 0.251 ± 0.025 | | |
| | | 0.653 ± 0.011 | | | |

TABLE 2
Summary of current density and open circuit potentials of non-magnetically
modified PEFCs as a function of CO exposure and percentage anode air bleed.
Catalyst and particle loading are approximately 0.4 mg/cm² Pt and 0.4 mg/cm²
polystyrene polymer coated Al₂O₃. Number of replicates given as n.

| % Air bleed and | Current Density (A/cm2) | | | | |
|---|---|---|---|---|---|
| CO concentration | 0.800 V | 0.700 V | 0.500 V | N | Open Circuit (V) |
| 0% air, 0 ppm CO | 0.159 ± 0.047 | | 0.476 ± 0.068 | 7 | 0.950 ± 0.020 |
| 0% air, 100 ppm | | 1.278 ± 0.092 | | 5 | 0.965 ± 0.020 |
| CO | 0.053 ± 0.036 | | 0.080 ± 0.053 | 6 | 0.977 ± 0.004 |
| 1.00 % air, 100 ppm | | 0.095 ± 0.053 | | 3 | 0.981 ± 0.001 |
| CO | 0.048 ± 0.032 | | 0.078 ± 0.054 | 3 | 0.973 ± 0.001 |
| 2.00 % air, 100 ppm | | 0.101 ± 0.062 | | | |
| CO | 0.018 ± 0.003 | | 0.028 ± 0.003 | | |
| 4.00 % air, 100 ppm | | 0.039 ± 0.003 | | | |
| CO | 0.022 ± 0.002 | | 0.033 ± 0.002 | | |
| | | 0.047 ± 0.004 | | | |

Copending Provisional U.S. Patent Application 60/587,908 filed on Jul. 15, 2004, titled “Carbon Monoxide Tolerance of Magnetically Modified PEFCs Through the Use of Anode Air Bleeds” to J. Leddy, W. Gellett and D. Dunwoody is hereby be incorporated by reference in its entirety, including all references cited therein.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

1. A method for improving performance of a magnetically modified fuel cell comprising an anode, a cathode and a polymer electrolyte membrane therebetween, said method comprising contacting said anode with a reformate fuel stream that contains an amount of oxygen effective to increase carbon monoxide tolerance of said fuel cell, wherein each of said anode and said cathode independently comprises an electrically conducting material having a catalytic material on at least a portion of a first surface thereof and further wherein each of said catalytic materials independently comprises an effective amount of at least one catalyst.

2. The method of claim 1, wherein said oxygen is supplied as air.

3. The method of claim 1, wherein said reformate fuel stream contains 0.50% to 2.50% air.

4. The method of claim 1, wherein said reformate fuel stream contains 1.00% to 2.00% air.

5. The method of claim 1, wherein said reformate fuel stream contains 1.00% to 1.50% air.

6. The method of claim 1, wherein said reformate fuel stream contains about 1.00% air.

7. The method of claim 1, wherein said reformate fuel stream is produced from a hydrocarbon.

8. The method of claim 7, wherein said hydrocarbon is selected from the group consisting of methanol, ethanol, propane, and methane.

9. The method of claim 1, wherein said reformate fuel stream is produced from a gasified biomass.

10. The method of claim 8, wherein said biomass is selected from the group consisting of coal, charcoal, wood, corn husks, coconut husks, and combinations thereof.

11. The method of claim 1, wherein said catalytic component comprises at least one member selected from the group consisting of platinum, palladium, nickel, iron, osmium, ruthenium, cobalt, gold, silver, copper, antimony, arsenic, molybdenum, tin, tungsten, alloys comprising one or more thereof, mixtures of two or more of said elements, mixtures of one or more of said elements and one or more alloys comprising one or more of said elements, and mixtures of alloys comprising one or more of said elements.

12. The method of claim 11, wherein said catalytic material further comprises at least one ion conducting material.

13. The method of claim 12, wherein said ion conducting material comprises a perfluorinated sulfonic acid polymer.

14. The method of claim 11, wherein said catalytic material further comprises at least one modifying material.

15. The method of claim 14, wherein said modifying material affects at least one property of said catalytic material selected from the group consisting of hydrophilicity, hydrophobicity, organophobicity, organophilicity, surface charge, dielectric constant, porosity, gas exclusion, gas permeability, deliquescence, wetting, density, electron conductivity and ionic conductivity.

16. The method of claim of claim 14, wherein said modifying material comprises at least one polyalkylene or a derivative thereof.

17. The method of claim 16, wherein said polyalkylene is polyethylene.

18. The method of claim 16, wherein said derivative is a partially or fully fluorinated polyalkylene.

19. The method of claim 1, wherein said catalytic material comprises a plurality of magnetic particles,
wherein each of said magnetic particles possesses a magnetic field of sufficient strength to alter the rate of and/or the distribution of products resulting from a chemical reaction involving said particle or occurring within the vicinity of said particle.

20. The method of claim 1, wherein said catalytic material comprises a plurality of magnetizable particles,
wherein said magnetizable particles have been or are exposed to a magnetic field of sufficient strength for a sufficient time to align the magnetic moments of a portion of atoms at least some of said particles, and
further wherein said portion of atoms aligned within each of said particles is sufficient to alter the rate of and or the distribution of products resulting from a chemical reaction involving said particle or occurring within the vicinity of said particle.

21. The method of claim 20, wherein said alignment is maintained upon removal of said magnetic field.

22. The method of claim 19, wherein each of said particles comprises a permanent magnetic material.

23. The method of claim 19, wherein each of said particles comprises a paramagnetic material.

24. The method of claim 19, wherein each of said particles comprises a superparamagnetic material.

25. The method of claim 19, wherein each of said particles comprises a ferromagnetic material.

26. The method of claim 19, wherein each of said particles comprises a ferrimagnetic material.

27. The method of claim 19, wherein each of said particles comprises a superconducting material.

28. The method of claim 19, wherein each of said particles comprises an anti-ferromagnetic material.

29. The method of claim 19, wherein each of said particles has a diameter of about 0.1 microns to about 50 microns.

30. The method of claim 19, wherein each of said particles comprises at least one element selected from the group consisting of samarium, neodymium, iron, boron, lithium, manganese, nickel, cobalt and zinc.

31. The method of claim 19, wherein each of said particles has at least one coating layer on at least a portion of the surface thereof.

32. The method of claim 31, wherein said coating layer comprises at least one inert material.

33. The method of claim 32, wherein said inert material comprises a silane or a silicon dioxide or a mixture thereof.

34. The method of claim 31, wherein said coating layer comprises at least one modifying material.

35. The method of claim 34, wherein said modifying material comprises at least one polymer.

36. The method of claim 35, wherein said polymer renders said particle chemically inert and/or mechanically stable.

37. The method of claim 34, wherein said modifying material affects at least one property of said particle selected from the group consisting of hydrophilicity, hydrophobicity, organophobicity, organophilicity, surface charge, dielectric constant, porosity, gas exclusion, gas permeability, deliquescence, wetting, density, electron conductivity and ionic conductivity.

38. The method of claim 34, wherein said modifying material is selected from the group consisting of homopolymers formed from the following monomers: styrene, styrene derivatives, 2-hydroxyethyl acrylate, 2-hydroxyethyl methacrylate, iso-decyl methacrylate, methyl methacrylate, methyl acrylate, vinyl acetate, ethylene glycol, ethylene, 1,3-dienes, vinyl halides, and vinyl esters.

39. The method of claim 34, wherein said modifying material is selected from the group consisting of copolymers formed from at least one Monomer A and at least one Monomer B, wherein said Monomer A is selected from the group consisting of styrene, methyl acrylate, iso-decyl methacrylate, 2-hydroxyethyl acrylate, and 2-hydroxyethyl methacrylate and said Monomer B is selected from the group consisting of 4-styrenesulfonic acid and ethylene glycol dimethacrylate.

40. The method of claim 31, wherein each of said particles has a plurality of coating layers.

41. The method of claim 34, wherein each of said particles has a plurality of coating layers.

42. The method of claim 41, wherein at least one of said plurality of coating layers comprises an inert material.

43. The method of claim 19, wherein said magnetic particle comprises at least one material selected from the group consisting of samarium cobalt, neodynium-iron-boron, iron and iron oxide, cobalt, misch metal, and ceramic magnets comprising barium ferrite and/or strontium ferrite.

44. The method of claim 1, wherein said polymer electrolyte membrane comprises at least one perfluorinated sulfonic acid polymer.

45. The method of claim 1, wherein said polymer electrolyte membrane has been subjected to at least one modifying process.

46. The method of claim 45, wherein said modifying process affects at least one property of said membrane selected from the group consisting of hydrophilicity, hydrophobicity, organophobicity, organophilicity, surface charge, dielectric constant, porosity, gas exclusion, gas permeability, deliquescence, wetting, density, electron conductivity and ionic conductivity.

47. The method of claim 45, wherein said modifying process enhances hydration of said membrane.

48. The method of claim 45, wherein said modifying process reduces the thickness of said membrane.

49. The method of claim 1, wherein the maximum thickness of said polymer electrolyte membrane is less than 20 mils.

50. The method of claim 1, wherein the maximum thickness of said polymer electrolyte membrane is less than 7 mils.

51. The method of claim 1, wherein the maximum thickness of said polymer electrolyte membrane is less than 5 mils.

52. The method of claim 1, wherein the maximum thickness of said polymer electrolyte membrane is between 1 mil and 7 mils.

53. The method of claim 1, wherein the maximum thickness of said polymer electrolyte membrane is about 2 mils.

54. The method of claim 1, wherein the maximum thickness of said polymer electrolyte membrane is about 1 mil.

55. The method of claim 1, wherein said catalytic material is present in an amount between 0.1 and 0.8 mg/cm².

56. The method of claim 43, wherein said catalytic material is present in an amount of about 0.4 mg/cm².

57. The method of claim 19 or 20, wherein said particles are present in an amount between 0.1 and 0.8 mg/cm².

58. The method of claim 19, wherein said particles are present in an amount of about 0.4 mg/cm².
